(19) United States
(12) Patent Application Publication
(10) Pub. No.: US 2013/0223880 A1
(43) Pub. Date: Aug. 29, 2013

(54) OUTPUT OF A CORONA CHARGER

(71) Applicant: Mark C. Zaretsky, Rochester, NY (US)

(72) Inventor: Mark C. Zaretsky, Rochester, NY (US)

(21) Appl. No.: 13/408,072

(22) Filed: Feb. 29, 2012

(51) Int. Cl. G03G 21/00

(52) U.S. Cl. 399/129

(57) ABSTRACT

A system for charging an insulating object on a static dissipative surface with a constant current includes a corona electrode in close proximity to the insulating surface; a shell electrode in close proximity to the corona electrode; a high voltage power supply connected to the corona electrode; wherein the potential of the shell electrode is raised to at least one tenth the magnitude of the potential of the corona electrode; sensing a first current from the high voltage power supply to the corona electrode; sensing a second current from the shell electrode to ground; and adjusting a voltage on the high voltage power supply to maintain a constant difference between the first current and the second current.

### CROSS REFERENCE TO RELATED APPLICATIONS

Reference is made to commonly-assigned copending U.S. patent application Ser. No. ______ (Attorney Docket No. K000925US01NAB), filed herewith, entitled IMPROVED OUTPUT OF A CORONA CHARGER, by Zaretsky; U.S. patent application Ser. No. ______ (Attorney Docket No. K000926US01NAB), filed herewith, entitled IMPROVED OUTPUT OF A CORONA CHARGER, by Zaretsky; and U.S. patent application Ser. No. ______ (Attorney Docket No. K000928US01NAB), filed herewith, entitled IMPROVED OUTPUT OF A CORONA CHARGER, by Zaretsky; the disclosures of which are incorporated herein.

### FIELD OF THE INVENTION

This invention pertains to the field of electrophotographic printing and more particularly to the charging, with a constant current, of an insulating object on a moving static dissipative member.

### BACKGROUND OF THE INVENTION

Electrophotography is a useful process for printing images on a receiver (or “imaging substrate”), such as a piece or sheet of paper or another planar medium, glass, fabric, metal, or other objects as will be described below. In this process, an electrostatic latent image is formed on a photoreceptor by uniformly charging the photoreceptor and then discharging selected areas of the uniform charge to yield an electrostatic charge pattern corresponding to the desired image (an “electrostatic latent image”).

After the electrostatic latent image is formed, charged toner particles are brought into the operative proximity of the photoreceptor and are attracted to the photoreceptor in such a manner as to convert or develop the electrostatic latent image into a visible image. It should be noted that the “visible image” includes images that may not be readily visible to the naked eye, depending on the composition of the toner particles (e.g. clear toner).

After the electrostatic latent image is developed into a visible image on the photoreceptor, the visible image is then electrostatically transferred to the receiver. There are at least two different variations on this process. In a direct transfer process (V1), the visible image is electrostatically transferred from the photoreceptor to the receiver by subjecting the toner image to an electrostatic field that urges the toner image from the photoreceptor to the receiver while pressing the receiver against the photoreceptor. This is often accomplished using an electrically biased transfer roller, although other methods are known in the art. A multicolor print is formed by repeating this direct transfer process multiple times. For example, a color print may be formed by combining separations corresponding to the subtractive primary colorants, cyan, magenta, yellow, and black, developed onto separate regions or frames on the photoreceptor. These separations are sequentially and in register transferred onto the receiver.

In an alternative version of a transfer process (V2), the toner image is first transferred from the photoreceptor to an intermediate transfer member, typically a static dissipative belt or roller, and then transferred from the intermediate transfer member to the receiver. A multicolor print can be printed in one of two methods using an intermediate transfer member. In the first method, the color separations are printed in separate frames on either the same photoreceptor or on separate photoreceptors. These color separations are then transferred, in register, to the intermediate transfer member. The registered images are then transferred to the receiver in a single pass. In the second method, each separation is first transferred to one or more intermediate transfer members, the separations remaining distinct while on the one or more intermediate transfer members. The separations are then transferred, in register, to the receiver. The separations can be transferred to individual areas or frames on the one or more intermediate transfer members and repeatedly transferring the separations, in register, to the receiver after all the separations had been transferred to the one or more intermediate transfer members. Alternatively, each separation can be transferred from an intermediate transfer member to the receiver prior to the transfer of a subsequent separation from the photoreceptor to the receiver. The toner image is fixed to the receiver by subjecting the toner bearing receiver to a combination of heat and pressure to soften and flow the toner.

For transfer variation V2, an intermediate transfer member is used to transfer toner onto the receiver. Typically the intermediate transfer member is static dissipative in nature, either through the bulk of the member or on the surface of the member. Static dissipative typically encompasses materials having a volume resistivity in the range of 10⁶ to 10¹² Ω-cm and/or a surface resistivity in the range of 10⁷ to 10¹³ Ω/square. After transferring toner onto the receiver there often is a residual of untransferred toner remaining on the intermediate transfer member. The residual toner must be removed from the intermediate transfer member by cleaning prior to the transfer of a subsequent toner image from the photoreceptor to the intermediate transfer member to avoid contaminating the subsequent toner image with residual toner, thereby degrading the image.

A variety of processes may be used to clean this member, including an electrostatic cleaning process whereby toner is electrostatically attracted from the member onto an electrically biased fiber brush, as described in U.S. Pat. No. 5,937,254. A corona charging device may be used to enhance the charge of the residual toner so as to improve the electrostatic removal of this toner from the surface of the intermediate transfer member. However, there is no method described for charging this toner as it resides on a static dissipative member. A difficulty in charging the toner is the sensitivity of the corona charging device operation to the resistivity of the intermediate transfer member. For a given corona charging current level, the surface potential of the intermediate transfer member will increase with higher resistivity (V=IR). This, in turn, will require higher corona electrode voltages in order to drive the desired current to the surface of the intermediate transfer member, increasing power consumption and concerns around arcing.

A method for applying a charge to a member such that a net charge flowing through a semi-conductive layer of a charge applying member is approximately zero is described in U.S. Pat. No. 5,897,247. This patent describes a corona charging device with an adjustable current output so as to maintain a total current, defined as the sum of all the currents flowing through the charge applying member, of roughly zero through the charge applying member. The corona charging device may be operated in a constant current mode. However, this reference does not describe any method to charge insulating residual toner on a static dissipative member in which the total current to the member may need to be significantly different from zero in order to effectively charge the toner. Furthermore, no method is described to allow one to compensate for variations in the resistivity of the member, in particular, the difficulty of depositing charge on a more resistive member.

A system for operating a corona charging device in a constant charging current mode is described in U.S. Pat. No. 5,079,669. The purpose of this device is to charge the surface of a photoreceptor to a uniform level and reduce sensitivity of the charging process to variations created by temperature, humidity, wear, and spacing between the charging device and the photoreceptor. In this invention the current flowing through the shell is summed with the current flowing to the photoconductor using a current summing node and employs a resistor to do so, as shown in FIG. 1. The voltage on shell 34 is determined by the product of Iₚ (photoconductor current) and resistor 84 and is of a low voltage on the order of 5V given Iₚ values on the order of 50 μA and resistor values on the order of 100 kΩ. This shell voltage is about 1000× lower than the wire voltage of 5 kV. Furthermore, the shell voltage is also the negative input to operational amplifier 64 and as such would typically be in the range of 0V to 5V.

Additionally, the photoreceptor is charged to a surface potential ranging in magnitude from 300V to 1000V, also significantly lower than the wire voltage. However, for a toner charging application on a static dissipative surface, the surface potential of the static dissipative receiver can rise significantly higher than 1000V when trying to charge the toner to a reasonable level. For example, a typical charging current might need to be in excess of 100 μA and a typical effective resistance for the static dissipative intermediate transfer member while under the corona charger may be 10 MΩ, resulting in a surface potential in excess of 1000V. This is difficult to achieve with a low shell voltage as a significant portion of the wire current will go to the low impedance shell rather than the high impedance (static dissipative member). This forces operation of the charger to higher current levels, necessitating wire voltages exceeding 5 kV and resulting in the arcing, charger geometry, and power consumption issues mentioned earlier. Therefore, the charging capability of this charger will be inadequate for the charging of low capacitance receivers at high speed.

A method for improving the charging efficiency of a corona charging device is described in U.S. Pat. No. 3,769,506. In this invention the charging output is enhanced by raising the potential of the shell to a voltage level of the same order of magnitude as the corona wire, either by connecting the shell to a second high voltage source or by connecting the shell to ground via a high resistance element. For example, using a shell resistance value of 10MΩ, a shell current flow of 10 μA/in, and a corona length of 10 inches, results in a shell voltage of 1 kV, well within an order of magnitude of a corona wire voltage range of 3.5 to 8 kV. This provides greater charging and power efficiency for the device. However, this device is operated as a constant voltage charging device for rapidly and uniformly charging the surface of an insulator to a uniform surface potential, with the insulator having a ground plane underneath, as for example a photoreceptor.

In a simple electrical circuit representation, the photoreceptor may be modeled as a capacitor (Cₚ) and the charging device may be represented by an ideal voltage source (V_{c}) and resistor (R_{c}). The charging time constant is given by τ_{RC}=R_{c}Cₚ. The residence time of the insulator within the charging zone is given by τᵣₑₛ=W/U where W is the width of the charging zone and U is the photoreceptor surface speed. The charging device exponentially charges up the capacitor to V_{c} and will be at 95% of V_{c} after 3 charging time constants. Typical for these applications is the desire to have τ_{RC}<τᵣₑₛ so as to operate at or near the saturation level of the charging curve, minimizing sensitivity to variations in the charging process and maximizing surface potential uniformity at a specified level. It should be noted that the surface charge density is not constant in a constant voltage charging mode. As such, a constant voltage charging mode would not work well for charging insulating residual toner on a static dissipative member where the need is to deposit a high level of charge regardless of the resistivity of the static dissipative member. Operation in the constant voltage mode would result in variable charge laydown, with residual toner on higher resistivity members receiving lower charge and therefore lower having poorer electrostatic cleanability. Although the corona wire voltage could be varied to obtain a desired charge laydown, doing so would require additional complexity and cost in order to measure the resistance of the intermediate transfer member. In addition, appropriate feedback control would be required to properly adjust the voltage to maintain constant current charging. This would add cost and complexity while degrading precision and robustness.

A method for charging a photoconductive surface utilizing a shell electrode connected to a high voltage DC power supply is described in U.S. Pat. No. 4,086,650. In this reference the shell electrode is biased to either a positive or negative voltage or is grounded depending upon the surface potential desired for the photoconductive surface to be charged. When used in combination with a dielectric coated corona wire biased to a high AC voltage, the uniformity of the surface potential on the photoconductor is improved. However, although this method is suitable to charge a photoreceptor to a specified surface potential, it would not be appropriate for a toner charging application, for the same reasons as described above. In addition, the high voltage DC power supply adds cost and power consumption to the device operation.

In tri-level xerography, corona charging devices are used to alter the surface potential of a toned photoreceptor in a tri-level xerographic process as described in U.S. Pat. Nos. 4,761,668; 4,868,611; and 5,809,382. For these processes, a corona charger is used to control the surface potential of a toned photoreceptor so as to produce a favorable situation for the subsequent deposition of a second toner having a charge polarity opposite to that of the toner previously deposited on the photoreceptor. The mode of operation for this charging device is to uniformly adjust the surface of the insulating photoreceptor to a desired constant potential. This device, therefore, would suffer the same limitations as discussed previously when used for applications requiring deposition of constant surface charge onto a insulating object on a moving static dissipative surface.

A method for adjusting toner charge on a photoconductive surface for tri-level xerography is described in U.S. Pat. No. 5,351,113. After depositing both positive and negative charged toner in the same image frame of the photoreceptor so as to form a two-color separation, one or more AC corona charging devices are used to reduce the difference in charge between the oppositely charged toner particles. This method utilizes the AC corona to reduce the magnitude of charge on each polarity toner. This is another example of modifying the charge of an insulating object on a moving insulating surface. This approach, however, would not work well in the present application where the need is to charge the residual toner particles on a static dissipative surface, not reduce their charge magnitude. Also, it is well known that AC corona charging devices have a much lower charging efficiency than DC corona because they are depositing charge of a given polarity for only a portion of the duty cycle, unlike DC corona which is constantly depositing charge of one polarity.

A method for simultaneously transferring a toner image having different toner charge polarities is described in U.S. Pat. No. 4,205,322. This method alters the charge of positive and negative charged toner particles residing on a photoreceptor surface so that all the toner particles have the same polarity charge, enabling transfer onto a receiver in a subsequent operation. A DC corona charger is shown consisting of a corona electrode connected to a high voltage DC power supply and a grounded shell electrode surrounding most of the corona electrode. This is another example of modifying the charge of an insulating object on a moving insulating surface, in particular a high capacitance photoconductive surface where the surface potential is limited in magnitude to roughly 1000V due to concerns of breakdown through the photoconductive layer. Therefore, this method suffers the same disadvantage as described earlier regarding the inability of this charging device to charge toner particles on a static dissipative surface that rises significantly above 1000V due to the combination of the resistivity of the static dissipative material and the current flow to the surface.

There is a continuing need, therefore, for an improved method of charging with constant current an insulting object on a moving, static dissipative member.

### SUMMARY OF THE INVENTION

Briefly, according to one aspect of the present invention a system for charging an insulating object on a static dissipative surface with a constant current includes a corona electrode in close proximity to the insulating surface; a shell electrode in close proximity to the corona electrode; a high voltage power supply connected to the corona electrode; wherein the potential of the shell electrode is raised to at least one tenth the magnitude of the potential of the corona electrode; sensing a first current from the high voltage power supply to the corona electrode; sensing a second current from the shell electrode to ground; and adjusting a voltage on the high voltage power supply to maintain a constant difference between the first current and the second current.

An advantage of this invention is that it provides an enhanced capability to charge insulating residual toner residing on a static dissipative member, enabling good electrostatic cleaning for a wide range in resistivity of the static dissipative member. Another advantage is this extended capability in charger output and efficiency may be achieved in a low cost manner with reduced power consumption. The invention and its objects and advantages will become more apparent in the detailed description of the preferred embodiment presented below.

### BRIEF DESCRIPTION OF THE DRAWINGS

FIG. 1 is an electrical schematic diagram for a constant current corona charging device as described in prior art.

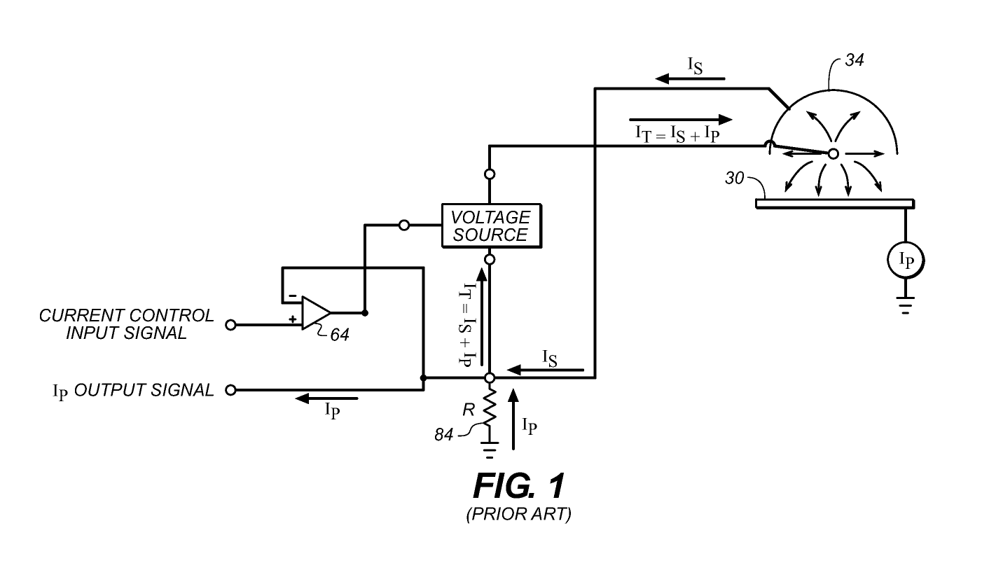

FIG. 2 is a schematic diagram of a toner residual charging system for charging insulating toner remaining on a moving, static dissipative transfer member.

FIG. 3 is a schematic diagram of a laboratory setup used to produce experimental data demonstrating the benefit of this invention.

FIG. 4 provides a chart of experimental data demonstrating the improved charger output of the invention.

FIG. 5 provides a chart of experimental data demonstrating the condition of the shell voltage raised to at least one tenth the corona electrode voltage.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

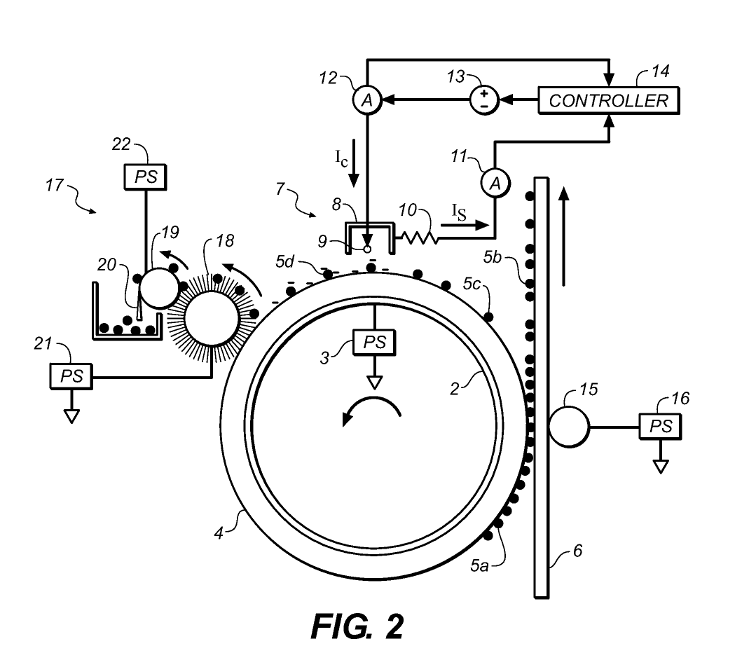

Referring now to FIG. 2, a schematic diagram is shown of a toner residual charging system for charging insulating toner remaining on a moving, static dissipative transfer member. Toner 5a has been deposited on the surface of static dissipative member 4 via an electrostatic process not shown in FIG. 2. This toner, typically ranging from 2 to 30 μm in diameter, has a net electrostatic charge of one polarity, taken here for illustrative purposes to be of negative polarity. Static dissipative member 4 has a conductive counter electrode 2 maintained at a fixed potential via power supply 3, the value of this potential may be zero or non-zero but is held constant for a period of time comparable to the transition of an image frame. As shown in FIG. 2, static dissipative member 4 is rotated counter-clockwise such that toner 5a is brought into contact with receiving member 6. Toner is electrostatically transferred to receiving member 6 via the establishment of an electric field between member 15 and counter electrode 2, with member 15 connected to power supply 16. As another example, member 15 could be a corona charging device used to deposit charge on receiving member 6 to establish an electrostatic field for attracting toner 5a. Receiving member 6 carrying transferred toner 5b is then conveyed on for a variety of purposes, including contact with another toned static dissipative member to accumulate multiple toner layers or to a fixing station where the toner is melted and adhered to the receiver.

As shown in FIG. 2, some residual toner 5c remains on static dissipative member 4 after contact with receiving member 6 and must be cleaned off so as to prepare static dissipative member 4 for another toner image. Removal of toner 5c may be accomplished using electrostatic brush cleaner 17 consisting of fiber brush 18, detone roller 19, skive blade 20, and power supply 21. In one example, fiber brush 18 is rotated counter-clockwise and consists of fibers having a conductive core and insulating sheath as described in U.S. Pat. No. 5,937,254. Power source 21 provides a voltage on the fibers so as to create an electric field that attracts toner 5d to fiber brush 18. For a negatively charged toner 5d, power supply 21 applies a positive voltage to fiber brush 18 that is higher than the potential of counter electrode 2, nominally in the range 100V to 600V higher. Detone roller 19 is a smooth conductive roller, also rotated counter-clockwise, is connected to power supply 22 and is raised to a potential higher than that of fiber brush 18 so as to electrostatically attract toner to the detone roller. The potential of detoner roller 19 is nominally 100V to 600V higher than that of fiber brush 18. Finally, skive blade 20 is used to scrape the toner off of detone roller 19. It is understood that other embodiments of the electrostatic cleaning brush may be used here with regards to parameters such as speed and direction of detone roller and fiber brush roller rotation.

It is important that residual toner 5d have sufficient charge so as to efficiently be removed from static dissipative member 4 by fiber brush 18. In order to ensure a sufficient level of charge, it is desirable to charge or re-charge insulating residual toner 5c using corona charging device 7. Corona charging device 7 consists of a corona electrode 9 and conductive shell 8. Corona electrode 9 is an electrical conductor connected via ammeter 12 to power supply 13 and raised to a high voltage. Ammeter 12 measures corona current I_{c} output by corona electrode 9. Corona electrode 9 is formed in a shape that creates an electric field that exceeds the breakdown strength of air either in the immediate vicinity of the electrode or at the electrode surface. For example, this shape may be a small diameter wire (less than or equal to 1 mm) or an array of pins or a set of bristles or fibers or a brush. Conductive shell 8 is connected through resistor 10 to ground via ammeter 11. Ammeter 11 measures current Iₛ collected by conductive shell 8 and is at a potential within a few volts of ground potential. The current of ammeter 11 is fed into controller 14. Controller 14 is used to monitor the difference in current measured by ammeters 12 and 11 and maintain a desired difference between I_{c} and Iₛ, by adjusting the output of power supply 13, resulting in a constant current flow to receiver 6. Alternatively, power supply 10 has the capability of sensing the current I_{c} supplied to corona electrode 9, sensing the current Iₛ collected by conductive shell 8 and returned through resistor 10, and the capability of adjusting the voltage on corona electrode 9 so as to regulate and maintain a desired difference in current between I_{c} and Iₛ, resulting in a constant current flow to static dissipative member 4. An example of a high voltage power supply having this capability is a Trek Cor-A-Trol Model 610C. In the process of depositing a constant current onto the surface of static dissipative member 4, a portion of the current will deposit onto toner 5c and charge or re-charge toner 5c so as to improve its cleanability by electrostatic brush cleaner 17. Resistor 10 is greater than 1 MΩ in value and preferably in the range of 5 MΩ to 20 MΩ.

In another embodiment, conductive shell 8 is connected to a high-voltage power supply and raised to a voltage of at least one tenth that of the corona electrode voltage so as to improve the charging output of corona charging device 7. Power supply 13 may be of a DC excitation, pulsed DC excitation, or AC excitation.

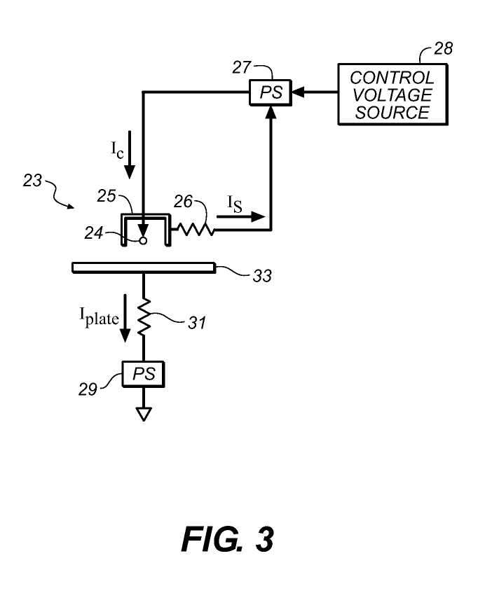

FIG. 3 shows a schematic diagram of an experimental setup used to provide experimental data demonstrating the benefit of one embodiment of the invention. A conductive metal plate 33 was spaced apart from corona charger 23. Conductive plate 33 was connected by resistor 31 (Rₚₗₐₜₑ) to power supply 29 capable of sinking and measuring current Iₚₗₐₜₑ while maintaining a constant voltage, simulating biased static-dissipative member 4 together with counter electrode 2 connected to power supply 3 (FIG. 2). In this case a Trek Cor-A-Trol Model 610C was used for power supply 29. Corona charger 23 consisted of corona wire electrode 24 and conductive shell 25. Corona wire electrode 24 was connected to the output of power supply 27. Conductive shell 25 was connected via resistor 26 (Rₛₕₑₗₗ) to an input of power supply 27. Power supply 27 was obtained from a NexPress 2100 press and provides a constant current output to conductive plate 33 (Iₚₗₐₜₑ), the difference between corona current I_{c} and shell ate, current Iₛ. This difference is specified by an input to power supply 27 from control voltage source 28. Furthermore, power supply 27 was limited to an output power level of nominally 6 W and an output total current of −800 μA, thereby limiting the maximum achievable Iₚₗₐₜₑ level. In the experiment, control voltage source 28 was varied so as to specify Iₚₗₐₜₑ levels ranging from 0 μA up to −570 μA. Rₚₗₐₜₑ was varied from 5 MΩ to 7.5 MΩ to 10.7 MΩ so as to simulate various levels of resistivity of static dissipative member 4. Rₛₕₑₗₗ was varied from 0 MΩ to 20 MΩ to characterize the change in charger output with increasing Rₛₕₑₗₗ.

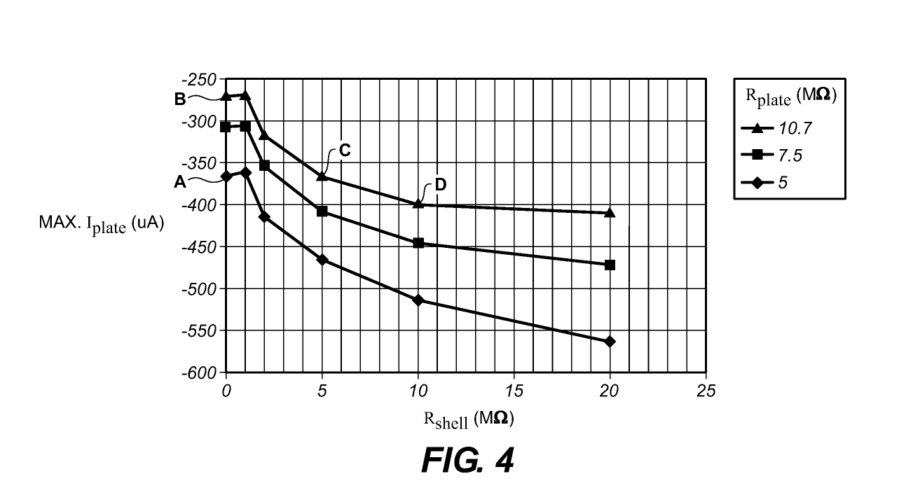

Data demonstrating the benefit of this invention is provided in FIG. 4. Three curves are shown, corresponding to the three different levels of Rₚₗₐₜₑ: 5 MΩ (diamond), 7.5 MΩ (square), and 10.7 MΩ (triangle). As can be seen from FIG. 4, the maximum level of Iₚₗₐₜₑ (vertical axis) that can be delivered by the corona charger increases with Rₛₕₑₗₗ (horizontal axis), with a maximum increase of roughly 50% for Rₛₕₑₗₗ=20 MΩ when compared to Rₛₕₑₗₗ=0 MΩ for a given curve. Furthermore, the addition of resistor Rₛₕₑₗₗ enables maintaining or increasing plate current in the face of increases in resistivity of resistor Rₚₗₐₜₑ. For example, with Rₛₕₑₗₗ=0 MΩ, as Rₚₗₐₜₑ increases from 5 to 10.7 MΩ, Iₚₗₐₜₑ decreases from −360 to −265 μA, comparing point A to point B. However, increasing Rₛₕₑₗₗ to 5 MΩ, restores Iₚₗₐₜₑ to −360 μA, as indicated by point C. Increasing Rₛₕₑₗₗ to 10 MΩ results in an even higher Iₚₗₐₜₑ of −400 μA, as indicated by point D.

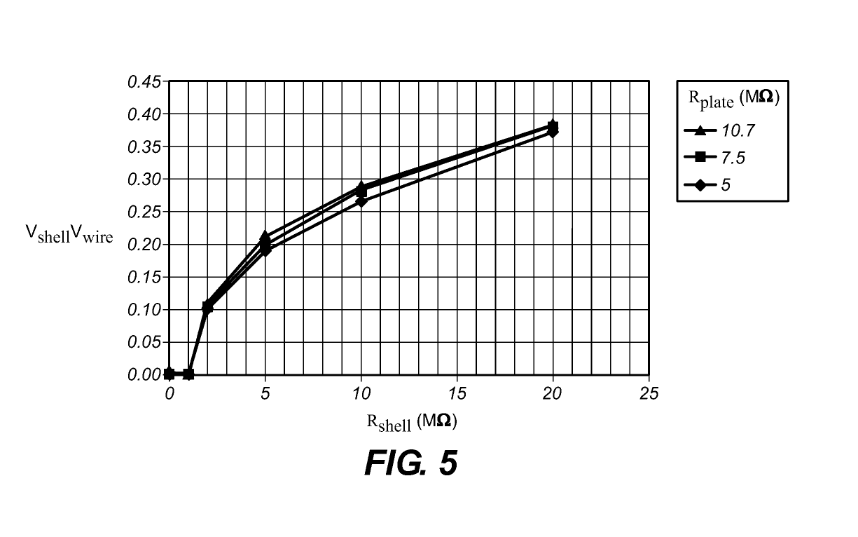

Data demonstrating the relationship between the shell voltage and corona electrode voltage is provided in FIG. 5. Three curves are shown for the same three levels of Rₚₗₐₜₑ as described above. It is evident that for Rₛₕₑₗₗ>1 MΩ for which a demonstrated benefit in charger output is achieved, as shown in FIG. 4, the shell voltage is at least one tenth the magnitude of the corona electrode voltage, that is (Vₛₕₑₗₗ/V_{wire})≧0.1.

The invention has been described in detail with particular reference to certain preferred embodiments thereof, but it will be understood that variations and modifications can be effected within the scope of the invention.

### PARTS LIST

2 counter electrode
3 power supply
4 static dissipative member
5a toner
5b toner
5c toner
5d toner
6 receiving member
7 corona charging device
8 conductive shell
9 corona electrode
10 resistor
11 ammeter
12 ammeter
13 power supply
14 controller
15 member
16 power supply
17 electrostatic brush cleaner
18 fiber brush
19 detone roller
20 skive blade
21 power supply
22 power supply
23 corona charger
24 corona wire electrode
25 conductive shell
26 resistor
27 power supply
28 control voltage source
29 power supply
31 resistor
33 conductive plate
34 shell
64 amplifier
84 resistor

1. A system for charging an insulating object on a static dissipative surface with a constant current comprising:
a corona electrode in close proximity to the insulating surface;
a shell electrode in close proximity to the corona electrode;
a high voltage power supply connected to the corona electrode;
wherein the potential of the shell electrode is raised to at least one tenth the magnitude of the potential of the corona electrode;
sensing a first current from the high voltage power supply to the corona electrode;
sensing a second current from the shell electrode to ground; and
adjusting a voltage on the high voltage power supply to maintain a constant difference between the first current and the second current.

2. The system of claim 1 wherein the shell is connected to ground through a resistor.

3. The system of claim 2 wherein the resistor is greater than 1 MΩ.

4. The method of claim 2 wherein the resistor is in the range of 5 MΩ to 20 MΩ.

5. The system of claim 1 wherein the shell is connected to a high-voltage power supply.

6. The system of claim 1 wherein the corona electrode is selected from a group consisting of corona wire, pin electrodes, or brush electrode.

7. The system of claim 1 wherein the high voltage power supply is selected from a group consisting of DC, pulsed DC or AC excitation.
